(19) United States
(12) Patent Application Publication
(10) Pub. No.: US 2010/0143222 A1
(43) Pub. Date: Jun. 10, 2010

(54) EXHAUST CONDENSATE REMOVAL APPARATUS FOR ABATEMENT SYSTEM

(76) Inventors: Phil Chandler, San Francisco, CA (US); Shaun W. Crawford, San Ramon, CA (US)

Correspondence Address: APPLIED MATERIALS/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/613,886

(22) Filed: Nov. 6, 2009

Related U.S. Application Data
(60) Provisional application No. 61/113,143, filed on Nov. 10, 2008.

(51) Int. Cl. B01D 53/86; F01N 3/24

(52) U.S. Cl. 423/212; 422/168; 422/176

(57) ABSTRACT

Exhaust condensate removal apparatuses for abatement systems and methods of removing exhaust condensate from abatement systems are described. An exhaust condensate removal apparatus includes a cabinet exhaust and a process gas exhaust, the process exhaust openly cross-exchanged with the cabinet exhaust. Another exhaust condensate removal apparatus includes a cabinet exhaust and a process gas exhaust, the process exhaust closedly cross-exchanged with the cabinet exhaust.

### CROSS REFERENCE TO RELATED APPLICATIONS

This application claims the benefit of U.S. Provisional Application No. 61/113,143, filed Nov. 10, 2008, the entire contents of which are hereby incorporated by reference herein.

### BACKGROUND

1) Field

Embodiments of the present invention pertain to the field of abatement systems and, in particular, to an exhaust condensate removal apparatus for an abatement system and a method of removing exhaust condensate from an abatement system.

2) Description of Related Art

Abatement systems can provide environmental abatement solutions for the semiconductor, solar and display industries. A wide range of point-of-use scrubbing systems are available, including wet, dry, thermal and integrated technologies for abatement of toxic and hazardous exhaust gases for a variety of applications. For example, some abatement systems handle complex effluent challenges ranging from a single unit to an entire fabrication facility.

### SUMMARY

Embodiments of the present invention include exhaust condensate removal apparatuses for abatement systems and methods of removing exhaust condensate from abatement systems.

In an embodiment, an exhaust condensate removal apparatus includes a cabinet exhaust. The exhaust condensate removal apparatus also includes a process gas exhaust. The process exhaust is openly cross-exchanged with the cabinet exhaust.

In another embodiment, a method of removing exhaust condensate from an abatement system includes providing a cabinet exhaust. The method also includes providing a process gas exhaust. The method also includes openly cross-exchanging the process gas exhaust with the cabinet exhaust.

In another embodiment, an exhaust condensate removal apparatus includes a cabinet exhaust. The exhaust condensate removal apparatus also includes a process gas exhaust. The process exhaust is closedly cross-exchanged with the cabinet exhaust.

In yet another embodiment, a method of removing exhaust condensate from an abatement system includes providing a cabinet exhaust. The method also includes providing a process gas exhaust. The method also includes closedly cross-exchanging the process gas exhaust with the cabinet exhaust.

### BRIEF DESCRIPTION OF THE DRAWINGS

FIG. 1 illustrates a block-diagram of an abatement system, in accordance with an embodiment of the present invention.

FIG. 2 illustrates a cross-sectional view of an abatement system, in accordance with an embodiment of the present invention.

FIG. 3 illustrates a block diagram of an exhaust condensate removal apparatus for an abatement system, in accordance with an embodiment of the present invention.

FIG. 4 illustrates a flowchart of a method of removing exhaust condensate from an abatement system, in accordance with an embodiment of the present invention.

FIG. 5 illustrates a block diagram of an exhaust condensate removal apparatus for an abatement system, in accordance with an embodiment of the present invention.

FIG. 6 illustrates a flowchart of a method of removing exhaust condensate from an abatement system, in accordance with an embodiment of the present invention.

### DETAILED DESCRIPTION

Exhaust condensate removal apparatuses for abatement systems and methods of removing exhaust condensate from abatement systems are described. In the following description, numerous specific details are set forth, such as system configuration, in order to provide a thorough understanding of embodiments of the present invention. It will be apparent to one skilled in the art that embodiments of the present invention may be practiced without these specific details. In other instances, well-known features, such as facility layouts, are not described in detail in order to not unnecessarily obscure embodiments of the present invention. Furthermore, it is to be understood that the various embodiments shown in the Figures are illustrative representations and are not necessarily drawn to scale.

Disclosed herein are exhaust condensate removal apparatuses for abatement systems. In one embodiment, an exhaust condensate removal apparatus includes a cabinet exhaust and a process gas exhaust, the process exhaust openly cross-exchanged with the cabinet exhaust. In one embodiment, an exhaust condensate removal apparatus includes a cabinet exhaust and a process gas exhaust, the process exhaust closedly cross-exchanged with the cabinet exhaust.

Also disclosed herein are methods of removing exhaust condensate from abatement systems. In one embodiment, a method includes providing a cabinet exhaust, providing a process gas exhaust, and openly cross-exchanging the process gas exhaust with the cabinet exhaust. In one embodiment, a method includes providing a cabinet exhaust, providing a process gas exhaust, and closedly cross-exchanging the process gas exhaust with the cabinet exhaust.

In accordance with an embodiment of the present invention, an abatement system destroys residual process gases through active flame oxidation and combustion for reliable and safe abatement. In one embodiment, effluent gases are heated by a flame in the main chamber of the system which provides ignition of flammable and pyrophoric gas by-products. In a specific embodiment, the advanced design of the flame ignition system ensures a stable flame with high inert gas flow. In an embodiment, an abatement system provides wet-scrubbing solutions that support up to four process effluent streams including those from challenging processes such as epitaxial silicon deposition and metal etch. In one embodiment, the abatement system handles perfluorocarbons (PFCs) and global-warming gasses. In another embodiment, the treatment of hydride and acid-based gases is performed in an abatement system. In one embodiment, by utilizing chemisorptive technology, process gases and by-products react with resin to form nonvolatile solids, an irreversible process that traps by-products and ensures safe disposal of the resin.

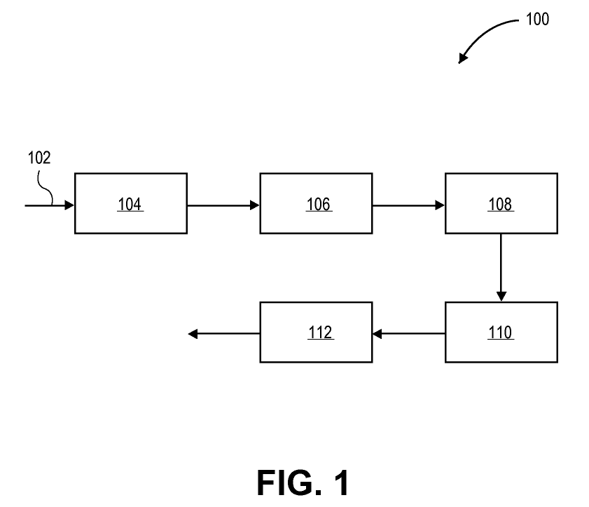

In an aspect of the present invention, an abatement system may include a combustion chamber or reactor. FIG. 1 illustrates a block-diagram of an abatement system, in accordance with an embodiment of the present invention. Referring to FIG. 1, abatement system 100 includes a gas inlet 102, a combustion chamber or reactor 104, a cooling chamber 106, a receiving tank 108, a scrubber 110, and an exhaust 112. In one embodiment, combustion chamber or reactor 104 includes a burner. In another embodiment, cooling chamber 106 is a waterfall cooling chamber configured with spray jets to spray water into a gas stream. In an embodiment, receiving tank 108 includes a large tank holding an amount of water at the bottom of the tank with space over-head for gas that is moving through the abatement system. In another embodiment, scrubber 110 sits directly above receiving tank 108. In a specific embodiment, scrubber 110 includes a spray shower for spraying water into a stream of effluent gases.

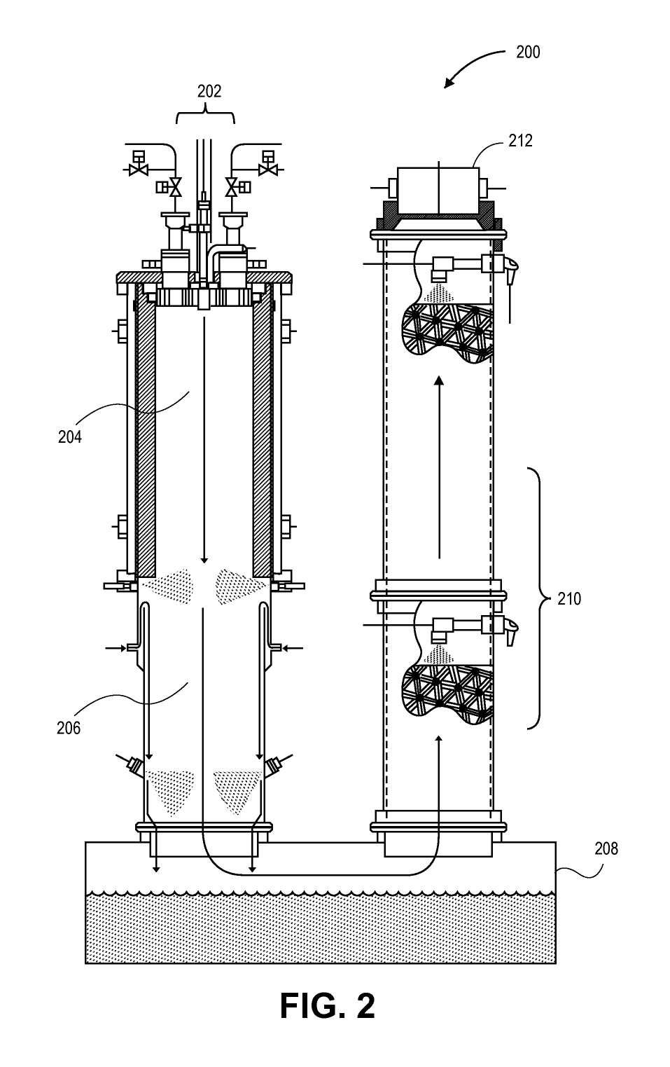

FIG. 2 illustrates a cross-sectional view of an abatement system, in accordance with an embodiment of the present invention. Referring to FIG. 2, abatement system 200 includes a gas inlet 202, a combustion chamber or reactor 204, a cooling chamber 206, a receiving tank 208, a scrubber 210, and an exhaust 212. In one embodiment, combustion chamber or reactor 204 includes a burner. In another embodiment, cooling chamber 206 is a waterfall cooling chamber configured with spray jets to spray water into a gas stream. In an embodiment, receiving tank 208 includes a large tank holding an amount of water at the bottom of the tank with space over-head for gas that is moving through the abatement system, as is depicted in FIG. 2. In another embodiment, scrubber 210 sits directly above receiving tank 208, as is also depicted in FIG. 2. In a specific embodiment, scrubber 210 includes a spray shower for spraying water into a stream of effluent gases.

In another aspect of the present invention, an abatement system may include an exhaust having a condensate removal mechanism. Conventionally, semiconductor, liquid crystal display and solar process chamber exhaust gases are fed to a point of use abatement system for treatment and then exhausted from the point of use abatement to a facility exhaust or scrubber system for further treatment or transmission to an outside environment. Many point of use abatement systems use water scrubbing to remove soluble chemicals from a gas stream, leaving the scrubbed gas stream saturated with water vapor. However, when this saturated gas stream exits the abatement unit and contacts the facility exhaust ducting, the water vapor may condense, leaving behind pools of slightly acidic liquid water that can cause the ducting to corrode and leak.

Instead, in accordance with an embodiment of the present invention, an abatement system includes an exhaust having a condensate removal mechanism. For example, in an embodiment, a dual exhaust arrangement is used in an abatement system and is configured to reduce the moisture content of a process gas exhaust. In one embodiment, the dual exhaust arrangement operates by cooling the exhaust gases using facility connection legs to promote water vapor condensation and liquid drainage back to the abatement system. In a specific embodiment, the arrangement prevents water from condensing and pooling in a facility main exhaust header. In an exemplary embodiment, an abatement system has two exhaust flows, a process gas exhaust, as described above, and a cabinet or enclosure ventilation exhaust. In one embodiment, the process gas exhaust is saturated with water vapor as a result passage of the exhaust gas through a water scrubber in the abatement system.

On the other hand, in one embodiment, the cabinet ventilation is moisture and temperature controlled air that is drawn from the facility, through the cabinet or enclosure and to the facility exhaust system. In accordance with an embodiment of the present invention, heat from the warm process gas exhaust, which is typically warmer than room air because of the heating or burning in a combustion chamber within the abatement system, is exchanged with room temperature cabinet exhaust to promote cooling of the process gas exhaust. In one embodiment, the heat exchange results in substantial water condensation in a process gas exhaust duct. In an embodiment, the cross exchange of the two exhausts is incorporated downstream of an abatement or integrated system, but prior to connection to a main facility exhaust header. In one embodiment, a slope on the exhaust duct work is provided to allow any water condensation in the duct work to flow back to an abatement system scrubber. The specific arrangement of the two exhausts can be arranged to enable this condensation process, two examples of which are described below.

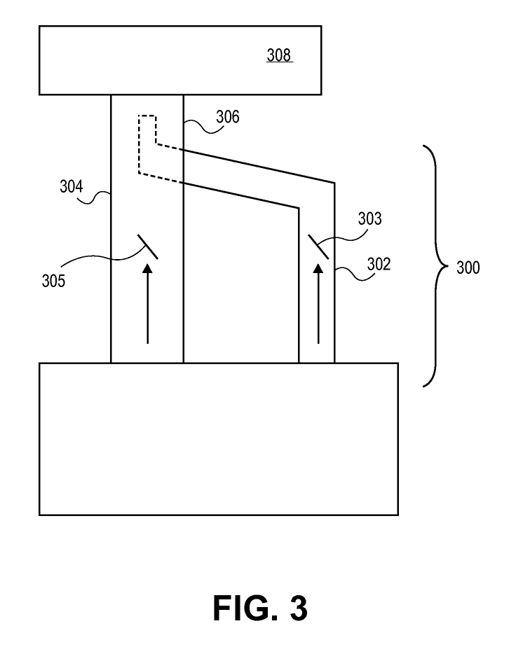

FIG. 3 illustrates a block diagram of an exhaust condensate removal apparatus for an abatement system, in accordance with an embodiment of the present invention. Referring to FIG. 3, an abatement system 300 combines both a process gas exhaust 302, having a slope 303, and a cabinet exhaust 304, having a slope 305, into a single exhaust header 306. In one embodiment, cross exchange of the exhausts is performed by using an annular duct design that routes process gas exhaust 302 vertically inside of cabinet exhaust 304 prior to mixing the two gas flows and immediately prior to entry into a main facility header 308, as depicted in FIG. 3.

Thus, an exhaust condensate removal apparatus for an abatement system may be provided. In an embodiment, the exhaust condensate removal apparatus includes a cabinet exhaust and a process gas exhaust, the process exhaust openly cross-exchanged with the cabinet exhaust. In one embodiment, the process exhaust is openly cross-exchanged with the cabinet exhaust by using an annular duct arrangement which routes the process gas exhaust vertically inside of the cabinet exhaust. In a specific embodiment, the annular duct arrangement is configured to mix a process gas flow from the process gas exhaust and a cabinet exhaust flow from the cabinet exhaust, the mixing approximately immediately prior to entry of the process gas flow and the cabinet exhaust flow into a main facility header. In one embodiment, the cabinet exhaust includes a first slope element, and the process gas exhaust includes a second slope element. In one embodiment, by openly cross-exchanging the process gas exhaust with the cabinet exhaust, the moisture content of a process gas flow is reduced.

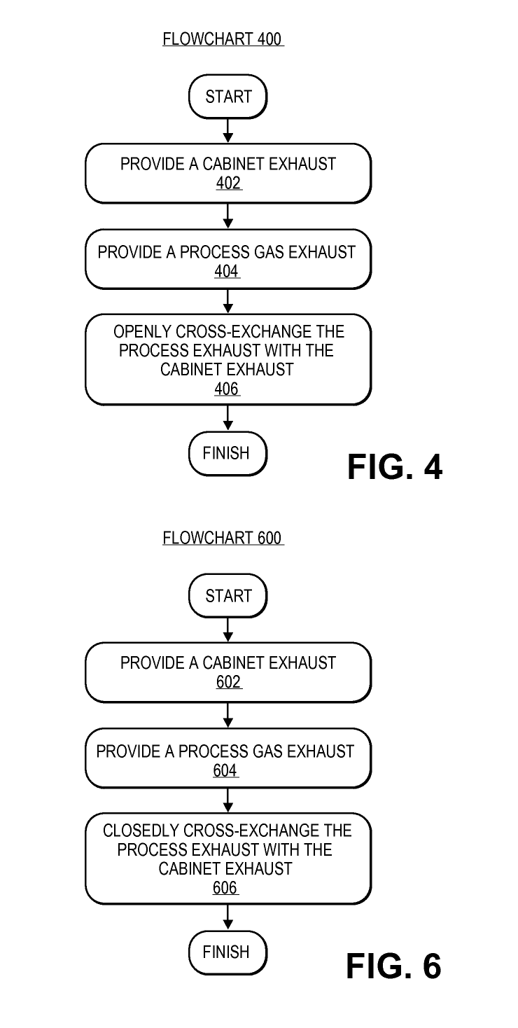

FIG. 4 illustrates a flowchart 400 of a method of removing exhaust condensate from an abatement system, in accordance with an embodiment of the present invention. In an embodiment, the method pertains to exhaust arrangements such as the exhaust arrangement described in association with FIG. 3.

Referring to operation 402 of flowchart 400, a method of removing exhaust condensate from an abatement system includes providing a cabinet exhaust. In accordance with an embodiment of the present invention, providing the cabinet exhaust includes providing a slope element in the cabinet exhaust.

Referring to operation 404 of flowchart 400, a method of removing exhaust condensate from an abatement system also includes providing a process gas exhaust. In accordance with an embodiment of the present invention, providing the process gas exhaust includes providing a slope element in the process gas exhaust.

Referring to operation 406 of flowchart 400, a method of removing exhaust condensate from an abatement system also includes openly cross-exchanging the process exhaust with the cabinet exhaust. In accordance with an embodiment of the present invention, openly cross-exchanging the process exhaust with the cabinet exhaust includes using an annular duct arrangement which routes the process gas exhaust vertically inside of the cabinet exhaust. In one embodiment, the annular duct arrangement is configured to mix a process gas flow from the process gas exhaust and a cabinet exhaust flow from the cabinet exhaust, the mixing occurring approximately immediately prior to entry of the process gas flow and the cabinet exhaust flow into a main facility header. In an embodiment, by openly cross-exchanging the process gas exhaust with the cabinet exhaust, the moisture content of a process gas flow is reduced.

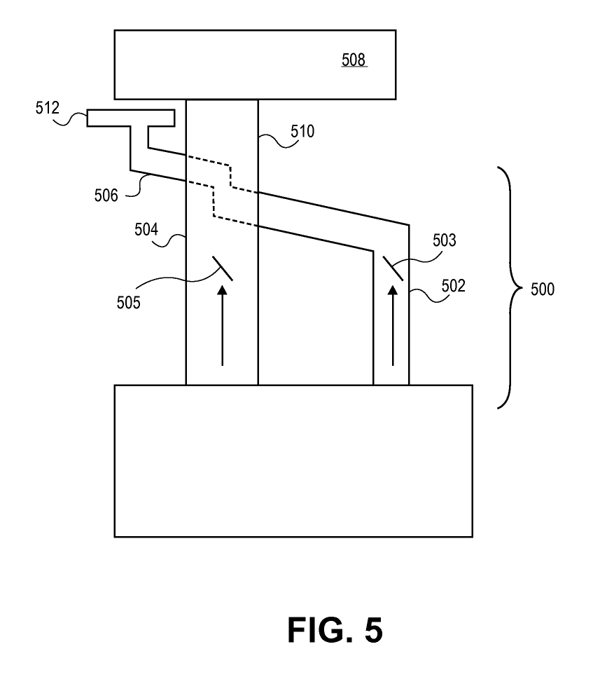

In another example, FIG. 5 illustrates a block diagram of an exhaust condensate removal apparatus for an abatement system, in accordance with an embodiment of the present invention. Referring to FIG. 5, an abatement system 500 includes a process gas exhaust 502, having a slope 503, and a cabinet exhaust 504, having a slope 505, are maintained as separate entities routed to two separate exhaust headers 506 and 510, respectively. In one embodiment, cross exchange of the exhausts is performed by routing the duct of process gas exhaust 502 into the larger line of cabinet exhaust 504 for a distance and then routing the duct back out of the line of cabinet exhaust 504 prior to connection with a separate pair of main facility headers 508 and 512, as depicted in FIG. 5.

Thus, an exhaust condensate removal apparatus for an abatement system may be provided. In an embodiment, the exhaust condensate removal apparatus includes a cabinet exhaust and a process gas exhaust, the process exhaust closedly cross-exchanged with the cabinet exhaust. In one embodiment, the process exhaust is closedly cross-exchanged with the cabinet exhaust by routing a duct of the process gas exhaust into the cabinet exhaust for a distance. In a specific embodiment, the duct of the process gas exhaust is further routed outside of the cabinet exhaust prior to coupling the process gas exhaust to a main facility header. In one embodiment, the cabinet exhaust includes a first slope element, and the process gas exhaust includes a second slope element. In one embodiment, by closedly cross-exchanging the process gas exhaust with the cabinet exhaust, the moisture content of a process gas flow is reduced.

FIG. 6 illustrates a flowchart 600 of a method of removing exhaust condensate from an abatement system, in accordance with an embodiment of the present invention. In an embodiment, the method pertains to exhaust arrangements such as the exhaust arrangement described in association with FIG. 5.

Referring to operation 602 of flowchart 600, a method of removing exhaust condensate from an abatement system includes providing a cabinet exhaust. In accordance with an embodiment of the present invention, providing the cabinet exhaust includes providing a slope element in the cabinet exhaust.

Referring to operation 604 of flowchart 600, a method of removing exhaust condensate from an abatement system also includes providing a process gas exhaust. In accordance with an embodiment of the present invention, providing the process gas exhaust includes providing a slope element in the process gas exhaust.

Referring to operation 606 of flowchart 600, a method of removing exhaust condensate from an abatement system also includes closedly cross-exchanging the process exhaust with the cabinet exhaust. In accordance with an embodiment of the present invention, closedly cross-exchanging the process exhaust with the cabinet exhaust includes routing a duct of the process gas exhaust into the cabinet exhaust for a distance. In one embodiment, the duct of the process gas exhaust is further routed outside of the cabinet exhaust prior to coupling the process gas exhaust to a main facility header. In an embodiment, by closedly cross-exchanging the process gas exhaust with the cabinet exhaust, the moisture content of a process gas flow is reduced.

Thus, exhaust condensate removal apparatuses for abatement systems and methods of removing exhaust condensate from abatement systems have been disclosed. In accordance with an embodiment of the present invention, an exhaust condensate removal apparatus includes a cabinet exhaust and a process gas exhaust, the process exhaust openly cross-exchanged with the cabinet exhaust. In one embodiment, the process exhaust is openly cross-exchanged with the cabinet exhaust by using an annular duct arrangement which routes the process gas exhaust vertically inside of the cabinet exhaust. In accordance with another embodiment of the present invention, an exhaust condensate removal apparatus includes a cabinet exhaust and a process gas exhaust, the process exhaust closedly cross-exchanged with the cabinet exhaust. In one embodiment, the process exhaust is closedly cross-exchanged with the cabinet exhaust by routing a duct of the process gas exhaust into the cabinet exhaust for a distance.

What is claimed is:

1. An exhaust condensate removal apparatus for an abatement system, the exhaust condensate removal apparatus comprising:
a cabinet exhaust; and
a process gas exhaust, the process exhaust openly cross-exchanged with the cabinet exhaust.

2. The exhaust condensate removal apparatus of claim 1, wherein the process exhaust is openly cross-exchanged with the cabinet exhaust by using an annular duct arrangement which routes the process gas exhaust vertically inside of the cabinet exhaust.

3. The exhaust condensate removal apparatus of claim 2, wherein the annular duct arrangement is configured to mix a process gas flow from the process gas exhaust and a cabinet exhaust flow from the cabinet exhaust, the mixing approximately immediately prior to entry of the process gas flow and the cabinet exhaust flow into a main facility header.

4. The exhaust condensate removal apparatus of claim 1, wherein the cabinet exhaust comprises a first slope element, and the process gas exhaust comprises a second slope element.

5. The exhaust condensate removal apparatus of claim 1, wherein by openly cross-exchanging the process gas exhaust with the cabinet exhaust, the moisture content of a process gas flow is reduced.

6. A method of removing exhaust condensate from an abatement system, the method comprising:
providing a cabinet exhaust;
providing a process gas exhaust; and
openly cross-exchanging the process exhaust with the cabinet exhaust.

7. The method of claim 6, wherein openly cross-exchanging the process exhaust with the cabinet exhaust comprises using an annular duct arrangement which routes the process gas exhaust vertically inside of the cabinet exhaust.

8. The method of claim 7, wherein the annular duct arrangement is configured to mix a process gas flow from the process gas exhaust and a cabinet exhaust flow from the cabinet exhaust, the mixing occurring approximately immediately prior to entry of the process gas flow and the cabinet exhaust flow into a main facility header.

9. The method of claim 6, wherein providing the cabinet exhaust comprises providing a first slope element in the cabinet exhaust, and providing the process gas exhaust comprises providing a second slope element in the process gas exhaust.

10. The method of claim 6, wherein by openly cross-exchanging the process gas exhaust with the cabinet exhaust, the moisture content of a process gas flow is reduced.

11. An exhaust condensate removal apparatus for an abatement system, the exhaust condensate removal apparatus comprising:
a cabinet exhaust; and
a process gas exhaust, the process exhaust closedly cross-exchanged with the cabinet exhaust.

12. The exhaust condensate removal apparatus of claim 11, wherein the process exhaust is closedly cross-exchanged with the cabinet exhaust by routing a duct of the process gas exhaust into the cabinet exhaust for a distance.

13. The exhaust condensate removal apparatus of claim 12, wherein the duct of the process gas exhaust is further routed outside of the cabinet exhaust prior to coupling the process gas exhaust to a main facility header.

14. The exhaust condensate removal apparatus of claim 11, wherein the cabinet exhaust comprises a first slope element, and the process gas exhaust comprises a second slope element.

15. The exhaust condensate removal apparatus of claim 11, wherein by closedly cross-exchanging the process gas exhaust with the cabinet exhaust, the moisture content of a process gas flow is reduced.

16. A method of removing exhaust condensate from an abatement system, the method comprising:
providing a cabinet exhaust;
providing a process gas exhaust; and
closedly cross-exchanging the process exhaust with the cabinet exhaust.

17. The method of claim 16, wherein closedly cross-exchanging the process exhaust with the cabinet exhaust comprises routing a duct of the process gas exhaust into the cabinet exhaust for a distance.

18. The method of claim 17, wherein the duct of the process gas exhaust is further routed outside of the cabinet exhaust prior to coupling the process gas exhaust to a main facility header.

19. The method of claim 16, wherein providing the cabinet exhaust comprises providing a first slope element in the cabinet exhaust, and providing the process gas exhaust comprises providing a second slope element in the process gas exhaust.

20. The method of claim 16, wherein by closedly cross-exchanging the process gas exhaust with the cabinet exhaust, the moisture content of a process gas flow is reduced.
